(19) United States
(12) Patent Application Publication
(10) Pub. No.: US 2003/0018950 A1
(43) Pub. Date: Jan. 23, 2003

(54) Dynamic redeploying environment for the rapid iterative development of software applications

(76) Inventors: Malcom Sparks, Co. Dublin (IE); Conrad O'Dea, Co. Dublin (IE); Jose Carlos Garcia-Sacristan, Co. Dublin (IE)

Correspondence Address: PENNIE AND EDMONDS, 1155 AVENUE OF THE AMERICAS, NEW YORK, NY, 100362711

(21) Appl. No.: 10/162,201

(22) Filed: Jun. 3, 2002

Related U.S. Application Data
(60) Provisional application No. 60/295,382, filed on Jun. 2, 2001.

(51) Int. Cl. G06F 9/44

(52) U.S. Cl. 717/100

(57) ABSTRACT

In one aspect, the present invention comprises a server system, the server system further comprising a generic server interface configured to receive requests for a plurality of software modules; a module locator configured to interrogate at least a first software module of the plurality of software modules based on an identifier from a request received via the generic server interface, and to cause the first software module to be invoked based on the interrogation; and a redeployment interface configured to receive a redeployment request, and in response to the redeployment request, to cause the module locator to interrogate a second module instead of the first module based on the identifier.

In another aspect, the invention comprises a client system, the client system further comprising a first software module comprising a generic client interface configured to receive at run-time a definition of an interface of a second software module and generate an invocation of the interface of the second software module via a generic server interface; the generic server interface being configured to receive requests for a plurality of software modules and to cause a module locator to interrogate the second software module based on an identifier from the invocation, and to cause the second software module to be invoked based on the interrogation.

### BACKGROUND OF THE INVENTION

Development and deployment of software applications in an application server environment has been a laborious task. The traditional iterative edit-compile-run software development and debugging cycle is slowed further by the need to reload modified code modules into the application server, frequently requiring server restart or other steps to deploy and test newly-revised modules.

For example, in the J2EE Enterprise Java Bean environment defined by Sun Microsystems, Enterprise Java Bean (EJB) servers typically require the server to be restarted in order to load newly-modified EJB classes and replace the older versions of the classes. In addition, new skeleton code may have to be generated on the server and new stub code may have to be generated for the client. Each of these activities typically requires attention from and actions by the developer before a new design iteration may be deployed and tested.

There is thus a need to reduce the number of steps that must be performed by the developer when redeploying an application in an application server environment.

### SUMMARY OF THE INVENTION

In one aspect, the present invention comprises a server system, the server system further comprising a generic server interface configured to receive requests for a plurality of software modules; a module locator configured to interrogate at least a first software module of the plurality of software modules based on an identifier from a request received via the generic server interface, and to cause the first software module to be invoked based on the interrogation; and a redeployment interface configured to receive a redeployment request, and in response to the redeployment request, to cause the module locator to interrogate a second module instead of the first module based on the identifier.

In another aspect, the present invention comprises a server system, the server system further comprising a generic server interface configured to receive service requests and to determine at least one type of at least one invocation parameter at run-time and to invoke a first software module with the parameter; a redeployment interface configured to receive an invocation and in response to the invocation, to cause the first software module to cease receiving invocations via the generic server interface, and a second software module to begin receiving invocations via the generic server interface.

In yet another aspect, the invention comprises a client system, the client system further comprising a first software module comprising a generic client interface configured to receive at run-time a definition of an interface of a second software module and generate an invocation of the interface of the second software module via a generic server interface; the generic server interface being configured to receive requests for a plurality of software modules and to cause a module locator to interrogate the second software module based on an identifier from the invocation, and to cause the second software module to be invoked based on the interrogation.

The server system is preferably configured to detect a change to a file comprising code representing the second software module and to invoke the redeployment interface to cause second software module to begin receiving invocations via the generic server interface. The server system is also further figured to cause the file to be compiled into the second software module.

### BRIEF DESCRIPTION OF THE DRAWINGS

FIG. 1 schematically depicts a server-side architecture for dynamic skeletons;

FIG. 2 is a schematic representation of a method for mapping an invocation of a server object;

FIG. 3 schematically depicts the class structure of a home servant in a preferred server-side architecture;

FIG. 4 schematically depicts the class hierarchy of an EJB container in a preferred server-side architecture;

FIG. 5 schematically depicts transactions in a preferred server-side architecture;

FIG. 6 schematically depicts the class hierarchy of a bean locator in a preferred server-side architecture;

FIG. 7 schematically depicts the class hierarchy of an entity map in a preferred server-side architecture; and

FIG. 8 schematically depicts the class hierarchy of an entity persistence in a preferred server-side architecture;

FIG. 9 schematically depicts a class diagram of a preferred client-side architecture for dynamic stubs;

FIG. 10 illustrates Java code for a preferred implementation of dynamic stubs.

### DESCRIPTION OF THE PREFERRED EMBODIMENTS

In one preferred embodiment, the present invention comprises a rapid-deployment system for Enterprise Java Beans (EJBs). By combining an EJB container that permits EJBs to be deployed without the need for generating skeleton code with a client proxy that permits EJBs to be deployed without the need for generating stub code, a dynamic class loader that permits EJBs to be deployed or redeployed without restarting the server, dynamic compilation which causes automatic compilation of changed code such as Java Server Pages (JSPs), and a single tool or command to cause recompilation and redeployment, the present invention greatly reduces the effort required of a developer of server applications to complete a modify-deploy cycle. Other preferred embodiments include the combination of the EJB container that supports deployment without generating skeleton code with any one or more of the other foregoing features. Although described with respect to the preferred EJB/J2EE embodiment, the present invention is not limited to that embodiment, but may be applied to any system in which redeployment of server software modules has conventionally required generation of skeleton code. Terminology frequently varies across distributed software systems (for example, skeletons are called stubs in some systems), but those of skill in the field will readily understand the corresponding structures across a wide variety of distributed computing systems.

The original EJB/J2EE container model defines a contract between developers and application servers. Developers produce components and application servers allow those components to be deployed with a number of guarantees such as security rights, transactionality, persistence and scalability. In conventional systems, implicit in this specification is the notion that application server products must generate the code responsible for these additional service levels from the components supplied.

In the present invention, these code-generation steps are avoided. This has a number of advantages: The deployed entities are closer to the original components supplied by the developer. The time usually taken in code generation steps is saved. The additional memory taken up by components in the application server is less, because no space needs to be reserved for additional application code The overall reliability of the application server is improved, because the application server code is prewritten rather than generated, and can be more thoroughly tested before release.

In a preferred embodiment, a single build tool is provided. This tool takes care of the compilation of the Java code making up components, compilation of Java Server Pages (see below) and the packaging of the components into the standard distribution units required by the J2EE specifications.

Dynamic skeletons are also preferably provided. Distributed systems force contracts between client and server code. These contracts are specified in some way—CORBA, for instance, uses an independent language, CORBA Interface Definition Language (IDL) to define contracts. EJBs use Java remote interfaces. The contracts themselves are independent of implementation, and are used to generate marshaling and un-marshaling code that is necessary to serially transmit data structures over network transports between computers.

In a preferred embodiment, the present invention uses an embedded Object Request Broker (ORB) to direct traffic to the correct EJB container and demarshal arguments. The container uses generic code to create the service levels required by the container. At the point at which the execution path must be handed over to the component, the container uses Java reflection (a standard part of the Java platform 1.1 and above, see http://java.sun.com/j2se/1.3/docs/guide/reflection/spec/java-reflectionTOC.doc.html) to invoke the business logic supplied by the component developer. This system is described in detail in PCT Application number PCT/US00/02262 published as WO 01129683 which is incorporated herein in its entirety by reference.

The use of dynamic skeletons means that no skeletons need to be generated to deploy new or modified application code. Components can therefore be deployed “as is” rather than forced through a series of code generation steps.

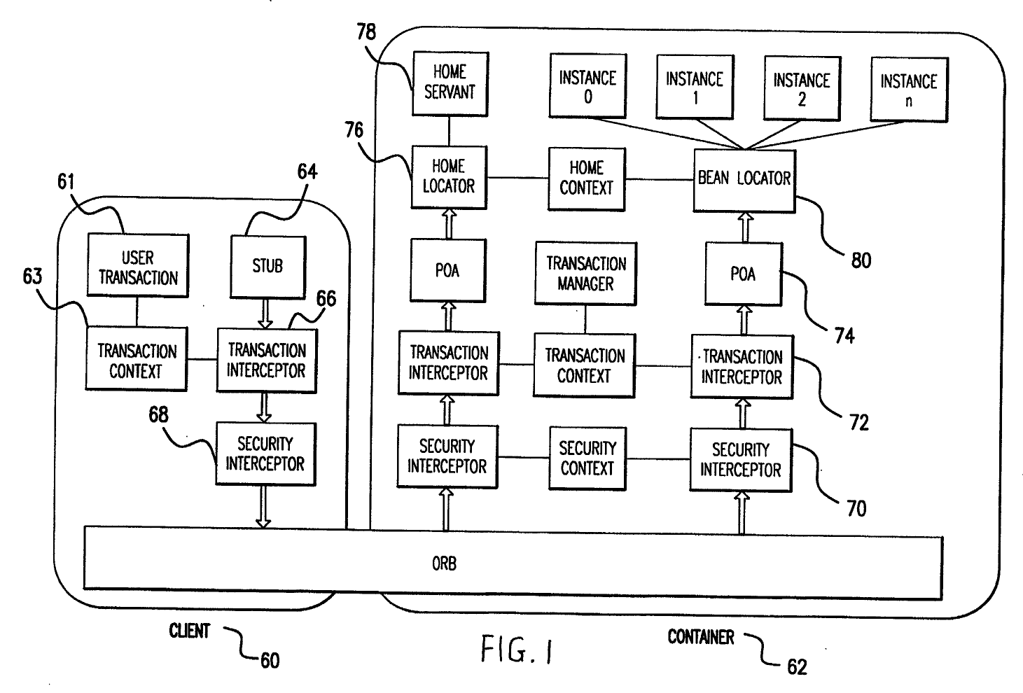

FIG. 1 schematically illustrates a preferred server-side architecture and a request from a client 60 to an EJB container of a server 62. The client 60 includes a stub 64 which marshals a message containing the request. The serialized message is then processed by a transaction interceptor 66 and a security interceptor 68 in sequence. Interceptors are filter objects through which messages pass. The messages may altered as they pass through the interceptor. A user transaction object 61, e.g., graphical user interface, and a transaction context object 63, which is a shared entity passed between operations associated with a single transaction, are also provided.

The message is transferred to the ORB which, in turn, sends the message to a container of the server 62 to which the message is destined. At the container, the message is processed by a security interceptor 70 and a transaction interceptor 72 sequentially. The message is then sent to an appropriate Common Object Request Broker Object Adapter (CORBA) Portable Object Adapter (POA) 74. The preferred embodiment includes two POAs: one for the EJBHome interface and the other for EJBObject objects. Depending upon whether the message is directed to EJBHome or to invoke a method on an EJBObject, the message is processed by the corresponding POA.

In particular, when the message is directed to the EJBHome, the message is sent to a Home Locator 76 and then sent to a Home Servant 78. In the preferred embodiment, only one Home Servant 78 is provided. When the message is to invoke a method on a EJBObject, the message is sent to a bean (servant) locator 80 which locates a bean instance, and is then sent to the located bean instance. It should be noted that the ties are only required (if at all) between the pre-invoke and the post-invoke of an operation. For instance, if the container has five simultaneous invocations on a bean, only five ties are required, i.e., one tie per instance.

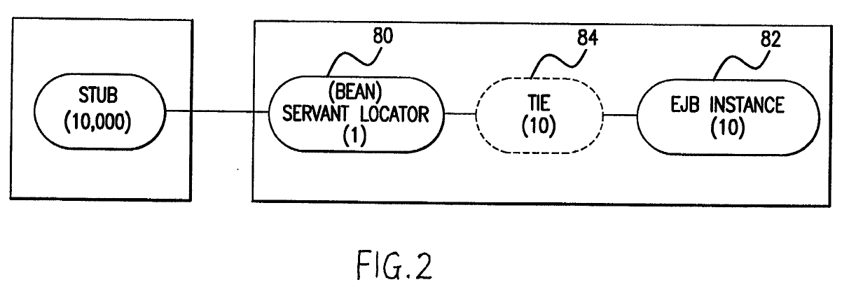

Referring to FIG. 2, as the bean locator 80 receives the request in the form of a serialized message from a client invoking an object on the server, the bean locator performs the container function of mapping a client request to a bean instance 82. There is one bean locator instance per POA in this preferred embodiment.

The conventional way of demarshaling the arguments from the serialized message is to use a skeleton produced from IDL or from a Java™ code. In this preferred embodiment, the name of operation to be invoked is first deciphered from the stream and, then, the Java reflection API is used to determine how to demarshal arguments of the operation from the stream. A single demarshaler is provided to demarshal method operations and return types from the stream in this preferred embodiment.

In other words, the dynamic skeleton of this embodiment forms a mapping from the reverse Java IDL operation name to the Java method. When the skeleton is invoked the serialized operation name is looked up in this map. The skeleton uses the Java reflection API to determine the number and type of operands expected for that operation, and the result type (if any). Each operand is demarshaled from the input stream according to its type given by reflection. Once the operands have been demarshaled the method is invoked by reflection.

In FIG. 2, the ties 84 are drawn with dashed lines because the servant locator is able by using reflection to demarshal the arguments from the IIOP stream and invoke the corresponding objects without requiring the use of a specific skeleton for each instance.

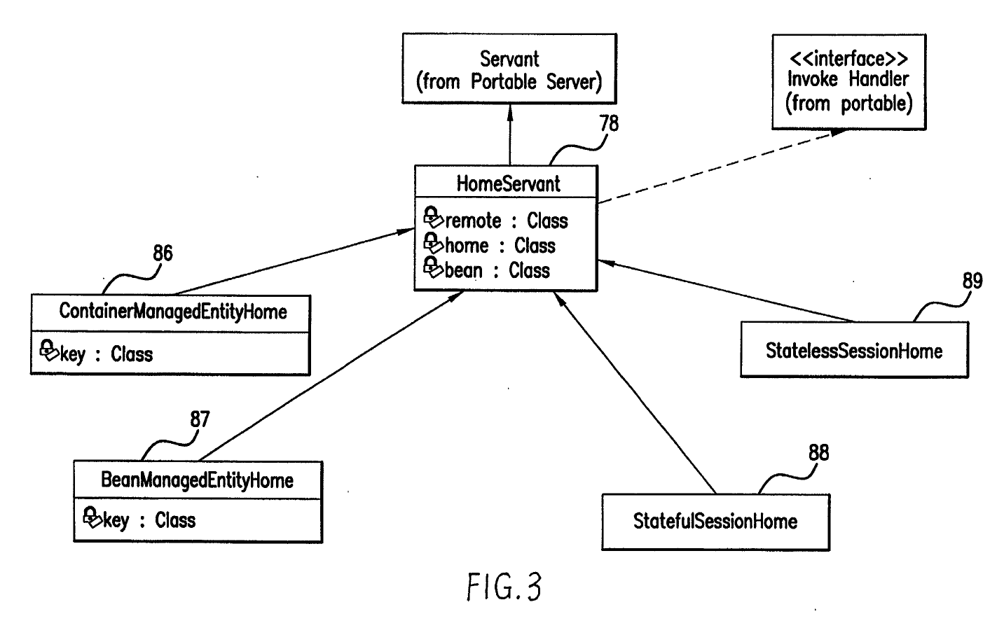

Now referring to FIG. 3, HomeServant 78 is an abstract class from which the Session and Entity homes are derived. HomeServant is a specialization of a CORBA servant that maps one of various types of homes of the EJB specification. The EJB specification details ContainerManagedEntityHome 86, BeanManagedEntityHome 87, StatefulSessionHome 88, and StatelessSessionHome 89. A portable servant is specialized in order to post home operations. For instance, the ContainerManagementEntityHome 86 would go to a data source that has been specified in the container code configuration to find or create new instances of a container managed entity EJB. Similarly, the BeanManagementEntityHome 87 calls EJB code that has been written by the bean provider to find or create objects.

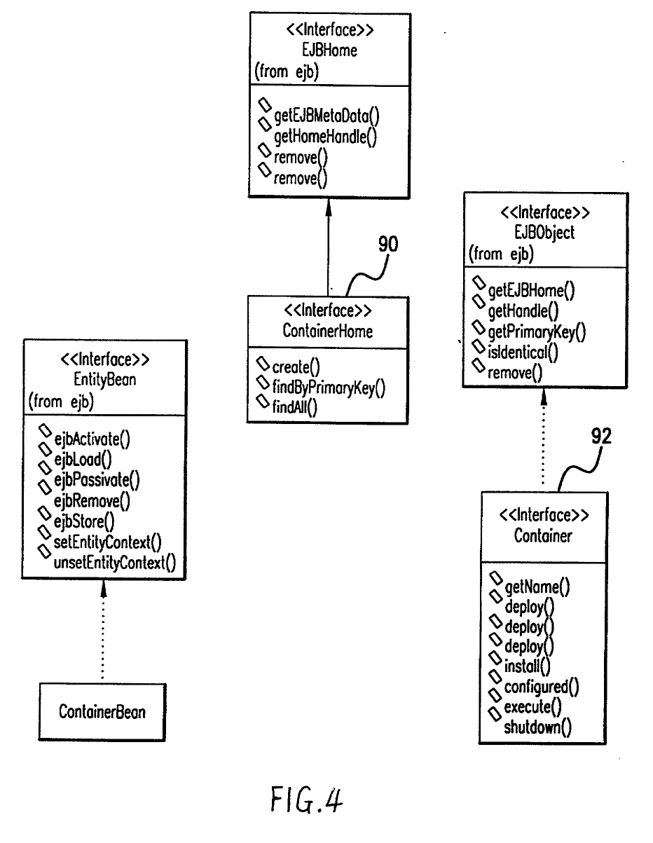

FIG. 4 schematically illustrates a class hierarchy of the container of this preferred embodiment. In particular, operations on the ContainerHome 90 are illustrated to show how containers are created. Once a container is created, the container can be found using the findByPrimaryKey( ) method with its corresponding homes or with all of the containers in a server. The findByPrimaryKey( ) operation returns a collection of containers. Container 92 schematically illustrates the container interface returned from the home. Container interface 92 can be used to deploy new java archives (jars) into the container and to configure a container, or shut down or start up a container.

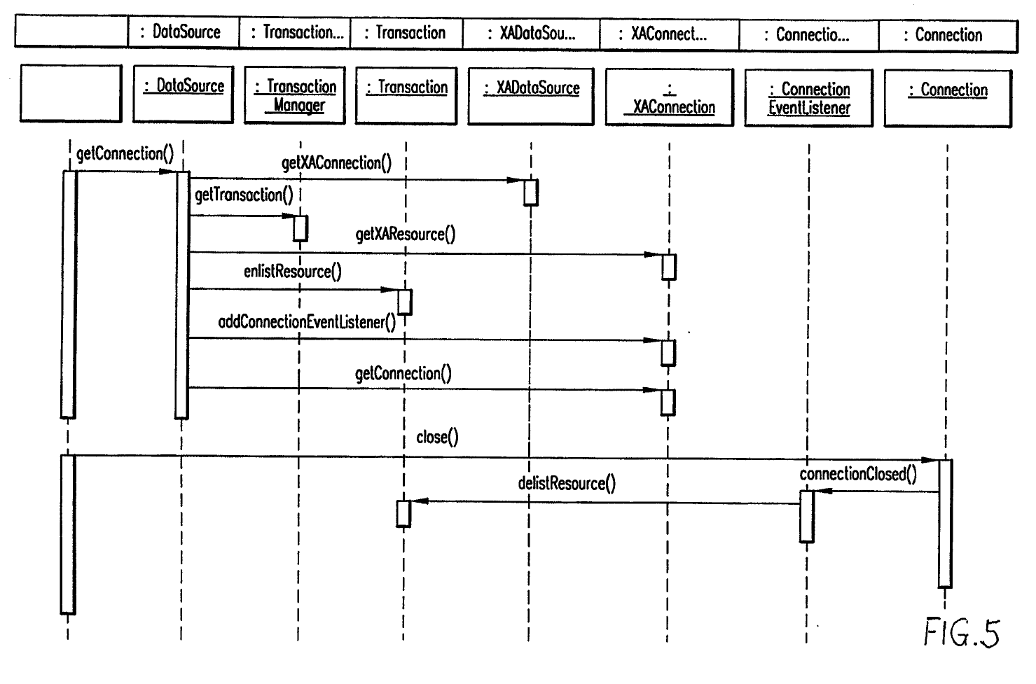

Referring to FIG. 5, the container of a preferred embodiment includes an eXtended Architecture (XA) compliant data source. In particular, the container provides a transaction aware data source that delegates to an existing XA compliant data source that has been registered using JNDI (Java Naming and Directory Interface). This facilitates enlisting XA resources into a transaction. The XA interface defines the contract between a Resource Manager and a Transaction Manager in a distributed object environment. The XA Resource interface can be supported by any transactional resource that is intended to be used by application programs in an environment where transactions are controlled by an external transaction manager. For a description of XA features, see the X/Open CAE Specification (December 1991) Distributed Transaction Processing: The XA Specification, which is incorporated herein by reference.

A call to getConnection( ) on the data source results in that connection being enlisted to a current transaction. A Transaction object checks whether the resource represented by the connection has already been enlisted in the transaction (XA start is called with TMJOIN), or whether a new transaction branch should be started (XA start is called with TMNOFLAGs). A call to close( ) causes the connection to be delisted.

An advantage of the container using XA connections internally is that a transactional bean instance is not attached to the database connection. In earlier EJBHome releases the instance was attached to the Java Database Connectivity (JDBC) connection for the duration of the transaction. This resulted in a potentially large number of JDBC connections in use. However, by using an underlying XA compliant data source, the container can rejoin transactions by presenting eXchange IDentifiers (XID) to the XA resource without having to tie the instance to the database connection.

The present invention preferably uses an external transaction factory to act as the root coordinator. An example of such a coordinator is the Object Transaction Monitor's (OTM) transaction factory, i.e., otstf.

Java Developer Kit (JDK) 1.2 provides the client-side stub code for the Java Transaction Service (JTS). A preferred present embodiment also provides two servant classes: Resourcelmpl and Synchronizationlmpl. The Resourcelmpl class wraps a javax.transaction.xa.XAResource as a Common Object Service (COS) transaction Resource. It maps javax.transaction.xa.XAException errors back into COS transaction exceptions. The SynchronizationImpl class wraps a javax.transaction.synchronization as a COS transaction Synchronization.

In terms of the Java Transaction API (JTA), the client views the transaction service via the UserTransaction interface. The container views the transaction service via the TransactionManager and TransactionInterfaces. The UserTransaction object is defined by the JTA specification and is used for client-demarcated transactions. It provides a simple API to begin, terminate or get the status of the current transaction. The container of the preferred embodiment implements the UserTransaction object. The UserTransaction object is registered as an initial reference with the ORB by the transaction plug-in. The underlying UserTransaction implementation uses the JTS.

The transaction context is preferably propagated over the wire in the format defined by the Transaction Service Specification using an interceptor chain. The interceptor caches the propagation context received from the transaction factory. For instance, a TransactionClientRequestInterceptor is typically used by the client to propagate a client-demarcated transaction. It is also used by the container when propagating the transaction context to another bean (in the case of a bean reference) or to another CORBA object. The TransactionClientRequestInterceptor always propagates the transaction context to the CORBA object. It preferably does not check that the object is a TransactionalObject, as this interface is deprecated in CORBA.

The JTS also specifies that the container uses the TransactionManager and TransactionInterfaces. The underlying Transaction and TransactionManager implementation uses the JTS.

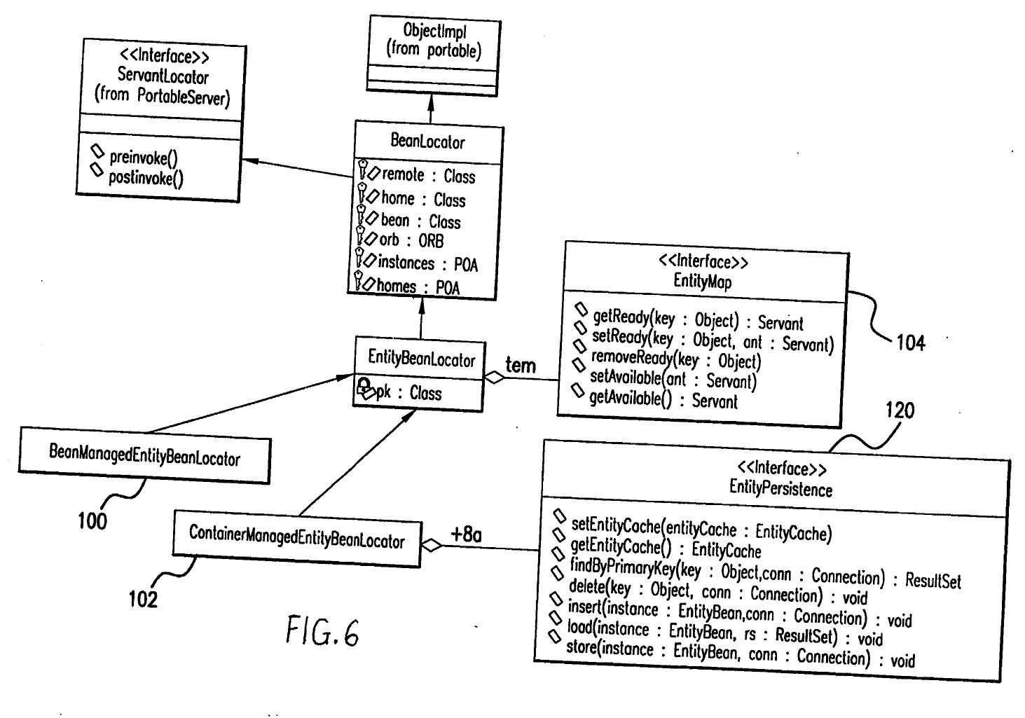

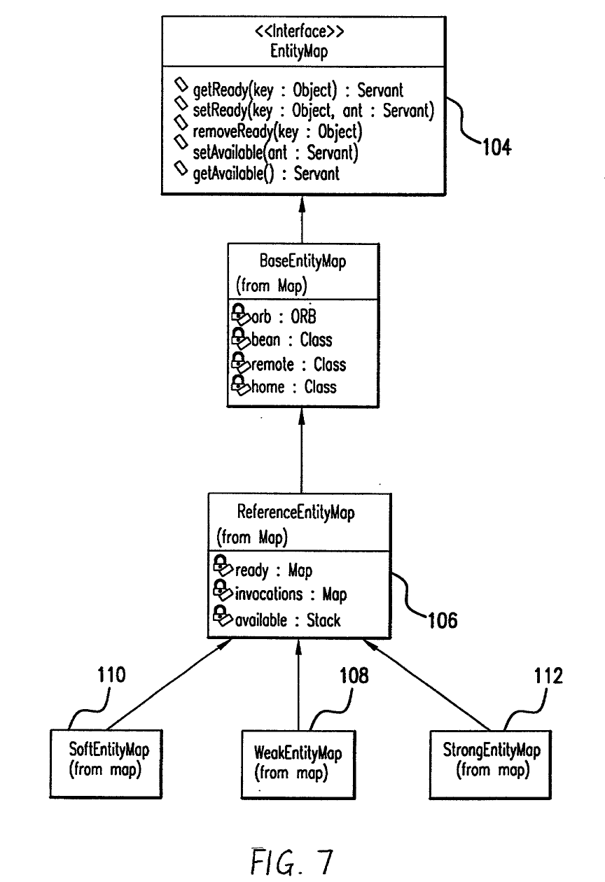

Now referring to FIG. 6, Entity beans of the present invention are split in the container into those that are bean-managed and to those that are container-managed, which are located by BeanManagedBeanLocator 100 and ContainerManagedEntityLocator 102, respectively. As shown in FIG. 7, an EntityMap 104 is responsible for maintaining the stack of available instances and a ready map. The ready map uses the primary key and transaction identifier to cache entity instances.

Referring again to FIG. 6, the ContainerManagedEntityBeanLocator 102 and the BeanManagedEntityBeanLocator 100 are written to use the interface EntityMap 104 in order to obtain instances from the available stack or from the ready map. The locators can be written without being aware of transactions (making their coding simpler), and allowing EntityMap 104 function to have multiple implementations (that may be specified by the container configuration).

Referring again to FIG. 7, the container of the present invention provides two implementations of the EntityMap 104 using reference objects. Reference objects are a feature of JDK2 that are integrated with the garbage collector, and a Reference object is given a call back by the garbage collector so that the program can perform clean up. The container uses these call backs to call ejbPassivate on the instance before it is garbage collected. In the implementation of the reference map, the reference object and the value (instance) are normal JDK objects.

A ReferenceEntityMap 106 implements the EntityMap 104 with either weak references (WeakEntityMap 108, reference objects that may be reclaimed at any time), soft references (SoftEntityMap 110, reference objects that are reclaimed once the JVM has run out of memory) or strong references (StrongEntityMap 112, normal JDK objects which will not be garbage collected).

The StrongEntityMap 112 requires that a passivator thread be used to provide the garbage collection function that is otherwise performed by the JVM for reference objects. In this case the passivation function should be configurable via the container configuration.

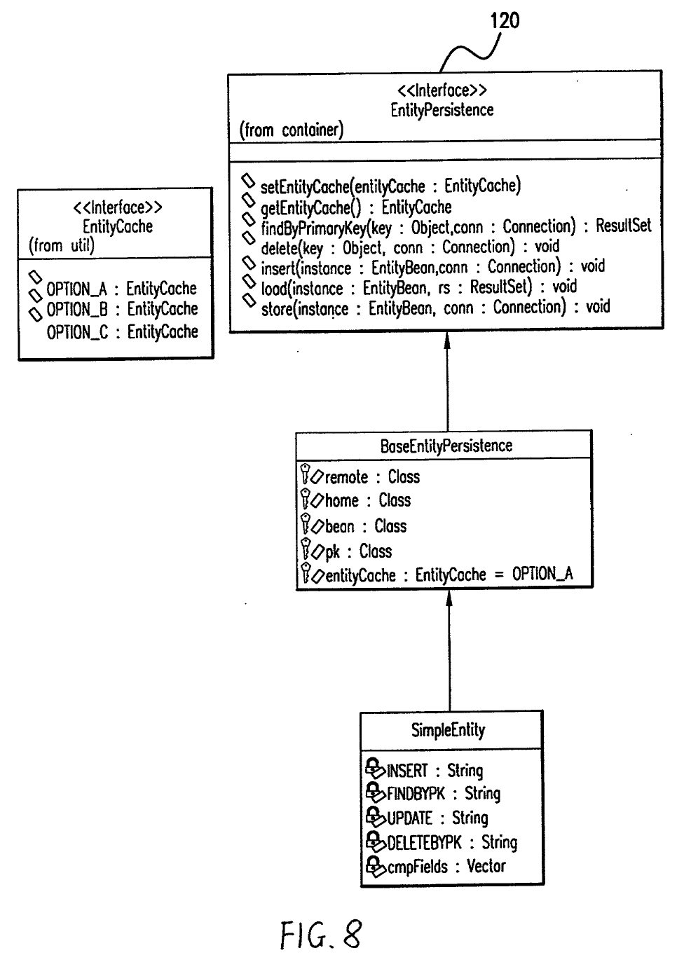

Referring to FIG. 8, container managed persistence is preferably provided in the ContainerManagedEntityBeanLocator 102 using an EntityPersistence 120 interface. Persistence is hidden behind this interface so that multiple implementations may be used. For example, an implementation may wish to take advantage of certain proprietary database features, or an implementation may use an object-relational mapping for complex types. The container of the present invention provides a simple persistence layer, which can handle the basic JDBC types supported by the underlying driver.

The POA policies used by the container for stateless session bean instances are: UNIQUE_ID, SYSTEM_ID, NO_IMPLICIT_ACTIVATION, TRANSIENT, NON-RETAIN and USE_SERVANT_MANAGER.

Invoking create on a stateless session home results in a new reference being created on the instance's POA. The POA is responsible for creating a unique identifier for the new instance. Stateless session beans are scalable in the container because it does not maintain a record of any objects that have been created.

The POA policies used by the container for stateful session bean instances are: UNIQUE_ID, SYSTEM_ID, NO_IMPLICIT_ACTIVATION, TRANSIENT, NON-RETAIN and USE_SERVANT_MANAGER.

Invoking create on a stateful session home results in a new reference being created on the instance's POA. The container is responsible for creating a unique identifier for the new instance and mapping the servant into the method ready state.

If the bean implements the SessionSynchronization interface the container registers a synchronization with the transaction manager on the first business method for that transaction. The container immediately invokes afterBegin on the instance. The transaction service invokes the beforeCompletion and afterCompletion callbacks on transaction commit or rollback.

The StatefulSessionBeanLocator registers with a timer to receive periodic callbacks on the actionPerformed method. These callbacks are used to passivate and timeout unused sessions.

Passivation of an unused session is implemented by serializing the instance to a temporary file. The container maintains a map of passivated instances. If an invocation is received for a passivated instance the container materializes the instance from the temporary file.

Passivation of a session involved in a transaction should only be done as a last resort. However, it may be achieved by serializing the propagation context together with the instance to disk. The instance can be materialized by the client (e.g., by invoking another method on the instance) or the transaction service invoking a call back (e.g., beforeCompletion). The bean locator can simply recreate the materialized propagation context with the transaction factory, and map the servant back into the container.

In addition to the dynamic skeletons described above, dynamic stubs are also preferably provided in a preferred embodiment. As with skeletons, stubs are responsible for marshaling the distributed invocation of a service call to the correct service, and for encoding the various parameters of such an invocation into a form that can be transported over a network connection. This is conventionally accomplished by generating stub code for each component.

The client code for a component invokes business routines on a component through a predefined interface. This interface is defined by the application developer and is unknown to the application server vendor. However, a feature in the Java platform (1.3 and above) allows the client code to discover the actual interface but trap any invocations on that interface so that marshaling can be done through a piece of generic logic, rather than generated logic. This exploits the “dynamic proxy” feature of the Java 2 platform (J2SE 1.3, see http://java.sun.com/j2se/1.3/docs/guide/reflection/proxy.html).

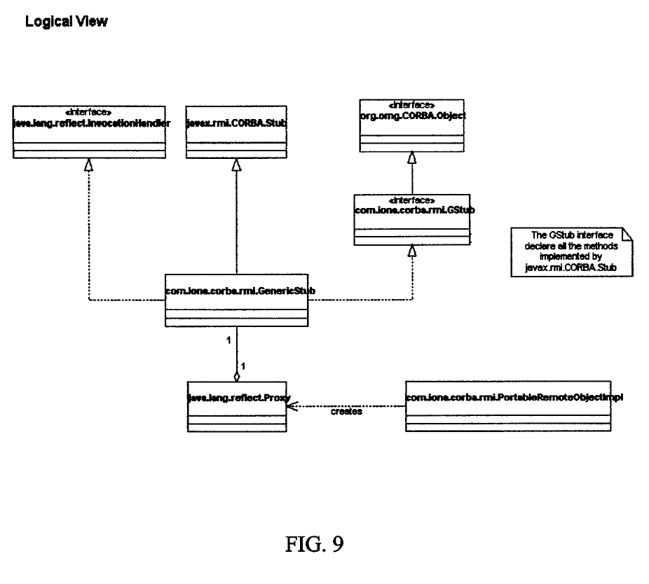

A Unified Modeling Language class diagram schematically illustrating the preferred implementation is shown in FIG. 9.

RMI-IIOP specifies the use of

javax.rmi.PortableRemoteObject.narrow(Object narrowFrom, Class narrowTo) to narrow are mote instance. PortableRemoteObject delegates in a delegate class,

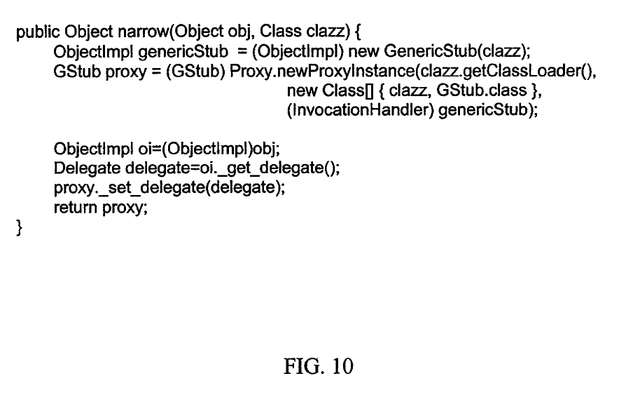

com.iona.corba.rmi.PortableRemoteObjectImpl in this preferred embodiment. It is in the narrow method of this class where the instance of java.lang.reflect.Proxy class is created. The code illustrated in FIG. 10 indicates how it is done (Exception checking is removed)

First an instance of GenericStub is created. GenericStub extends from javax.rmi.CORBA.Stub, and for this reason it can also implement GStub without adding specific methods. It also implements java.lang.reflect.InvocationHandler. So the proxy instance that will be created in the next instruction will delegate to this GenericStub instance. Requests are executed in the invoke method required by the InvocationHandler interface.

Next, a java.lang.reflect.Proxy instance is created that will implement the class that the object will be narrowed to, and the Gstub interface. The GStub interface is needed because any javax.rmi.CORBA.Stub method has to be able to be invoked in the proxy instance. This feature is used to invoke the Stub method _set_delegate in the proxy instance. Finally the proxy instance is returned.

When a method is invoked on the proxy instance, the proxy instance calls invoke on the InvocationHandler, in this embodiment the GenericStub instance. A java.lang.reflect.Method is passed as a parameter, as well as the arguments needed to invoke this method. Using reflection, the parameter types are extracted from the Method instance, and by using _invoke inherited from javax.rmi.CORBA.Stub, an invocation is made to the server. Then, the returned object is converted to the expected return type of the Method instance and returned to the caller.

The combination of dynamic stubs and dynamic skeletons means that no code need be generated for components—the complete code necessary for marshaling requests is already part of the system that clients and components are executed upon.

Dynamic class loading is also preferably provided. Generally, once Java classes are loaded into the Java Virtual Machine (JVM) they are there for the duration of the JVM process. In a preferred embodiment of the present invention, the system dynamically and automatically reloads classes if it detects that the code has been changed by the developer. Rather than having to restart the server, or redeploy the application (or both), the developer can immediately see the result of his change after the build/package step.

Classes in Java are not built into the executable image like in other languages, but are loaded at runtime. Java delegates this responsibility to an object called a ClassLoader. ClassLoader itself is a superclass that all class loaders inherit from.

When a class is loaded by a class loader, it is associated with that class loader for all it's life, in other words, until it is garbage collected. The same class file can be loaded by different class loaders—in this case the class would be duplicated in the JVM, class loaders therefore give a degree of sandboxing or isolating sets of classes from other sets of classes.

Class loaders are themselves objects. When no other object in the JVM references a class loader, it is considered suitable for garbage collection. Whether it is garbage collected or not, it is no longer accessible by any other objects. For this to happen, however, all class instances arising from classes in a class loader must themselves have been dereferenced, since class instances reference their classes, and classes reference their class loaders.

In a preferred embodiment, the present server system manages class loaders, and can dereference an entire deployed application by dereferencing the class loaders associated with that application. This effectively un-deploys the application. By combining an un-deploy with a deploy of a new version, a redeploy suitable for iterative development results. All EJBs, servlets and other artifacts of an application are dereferenced, and the old class loader references are refreshed to point to new class loader instances.

The use of dynamic class loading also extends to the client, if the client is running within the container. This would be the case if one contained component were making an invocation on another component. In this case, the new interface is loaded so that the call is compatible with the new server-side implementation of the modified component.

Dynamic JavaServer Pages (JSP) compilation is also preferably provided. JSPs are HTML-based documents but with the difference that application code can be embedded into the content. Each JSP document can be “compiled” into a pure-Java Servlet that produces the actual web page.

Although certain conventional Java Servlet engines such as Tomcat provide dynamic JSP compilation, they do not do so in combination with the other features of the present system, and therefore do not provide the substantial advantages of the combination of features described here. For example, if a JavaServer Page (JSP) is altered, the system detects this and regenerates the servlet implementation on the next build. The container can automatically reload the servlet class so that the change can be tested immediately, without having to recycle the server or redeploy the application into the server.

Although the invention has been described here with reference to the preferred EJB/J2EE embodiment, the invention is applicable to a broad range of distributed computing systems, and is not intended to be limited to the specific preferred embodiments described above.

What is claimed is:

1. A server system, comprising:
a generic server interface configured to receive requests for a plurality of software modules;
a module locator configured to interrogate at least a first software module of the plurality of software modules based on an identifier from a request received via the generic server interface, and to cause the first software module to be invoked based on the interrogation;
a redeployment interface configured to receive a redeployment request, and in response to the redeployment request, to cause the module locator to interrogate a second module instead of the first module based on the identifier.

2. A server system, comprising:
a generic server interface configured to receive service requests and to determine at least one type of at least one invocation parameter at run-time and to invoke a first software module with the parameter;
a redeployment interface configured to receive an invocation and in response to the invocation, to cause the first software module to cease receiving invocations via the generic server interface, and a second software module to begin receiving invocations via the generic server interface.

3. A client system, comprising:
a first software module comprising a generic client interface configured to receive at run-time a definition of an interface of a second software module and generate an invocation of the interface of the second software module via a generic server interface;
the generic server interface being configured to receive requests for a plurality of software modules and to cause a module locator to interrogate the second software module based on an identifier from the invocation, and to cause the second software module to be invoked based on the interrogation.

4. The server system of claim 1 or 2, wherein the system is further configured to detect a change to a file comprising code representing the second software module and to invoke the redeployment interface to cause second software module to begin receiving invocations via the generic server interface.

5. The server system of claim 5, wherein the system is further figured to cause the file to be compiled into the second software module.

6. The system of claim 1, 2, 3, 4, or 5 wherein the generic server interface is defined in Java.

7. The system of claim 1, 2, 3, 4, or 5 wherein the generic server interface is defined in CORBA IDL.
